(19) United States
(12) Patent Application Publication
(10) Pub. No.: US 2003/0076371 A1
(43) Pub. Date: Apr. 24, 2003

(54) Scanning techniques in selective deposition modeling

(75) Inventor: Jon Jody Fong, Calabasas, CA (US)

Correspondence Address: James E. Curry, 3D Systems, Inc., 26081 Avenue Hall, Valencia, CA, 91355, US

(73) Assignee: 3D Systems, Inc., Valencia, CA (US)

(21) Appl. No.: 10/000,854

(22) Filed: Oct. 24, 2001

(51) Int. Cl. B41J 2/01

(52) U.S. Cl. 347/1

(57) ABSTRACT

A unique scanning technique for selective deposition modeling wherein the dispensing device remains substantially stationary as the object staging structure supporting the three-dimensional objects being formed is reciprocally driven in a main scanning direction. A more uniform temperature environment is provided for the dispensing device which can achieve a more uniform drop mass when dispensing a curable material. Also provided is a unique biased air flow for cooling the layers of the object as they are formed as they release a substantial amount of exothermal heat. The biased air flow is directed away from the dispensing device so a to provide a more uniform temperature environment for the dispensing device while removing the substantial amount of heat from the layers.

### BACKGROUND OF THE INVENTION

1. Field of the Invention

The invention relates in general to scanning techniques for solid freeform fabrication and, in particular, to a scanning technique where the dispensing device remains substantially stationary when dispensing material along a main scanning direction. Further, the invention relates to providing a more constant and uniform temperature for the dispensing device used in conjunction with the new selective deposition modeling scanning technique so as to achieve more uniform drop mass when dispensing material.

2. Description of the Prior Art

Recently, several new technologies have been developed for the rapid creation of models, prototypes, and parts for limited run manufacturing. These new technologies can generally be described as solid freeform fabrication, herein referred to as “SFF”. Some SFF techniques include stereolithography, selective deposition modeling, laminated object manufacturing, selective phase area deposition, multi-phase jet solidification, ballistic particle manufacturing, fused deposition modeling, particle deposition, laser sintering, and the like. In SFF, complex parts are produced from a modeling material in an additive fashion as opposed to conventional fabrication techniques, which are generally subtractive in nature. For example, in conventional fabrication techniques material is removed by machining operations or shaped in a die or mold to near net shape and then trimmed. In contrast, additive fabrication techniques incrementally add portions of a build material to selected locations, typically layer by layer, in order to build a complex part.

SFF technologies typically utilize a computer graphic representation of a part and a supply of a build material to fabricate the part in successive layers. SFF technologies have many advantages over the prior conventional manufacturing methods. For instance, SFF technologies dramatically shorten the time to develop prototype parts and can quickly produce limited numbers of parts in rapid manufacturing processes. They also eliminate the need for complex tooling and machining associated with the prior conventional manufacturing methods, particularly when creating molds for casting operations. In addition, SFF technologies are advantageous because customized objects can be produced quickly by processing computer graphic data.

One category of SFF that has emerged is selective deposition modeling, herein referred to as “SDM”. In SDM, a build material is dispensed in a layerwise fashion while in a flowable state and allowed to solidify to form an object. In one type of SDM technology the modeling material is extruded as a continuous filament through a resistively heated nozzle. In yet another type of SDM technology the modeling material is jetted or dropped in discrete droplets in order to build up a part. In one particular SDM apparatus, a thermoplastic material having a low-melting point is used as the build material, which is delivered through a jetting system such as those used in ink jet printers. One type of SDM process utilizing ink jet print heads is described, for example, in U.S. Pat. No. 5,555,176 to Menhennett, et al.

Because ink jet print heads are designed for use in two-dimensional printing, special modifications must be made in order to use them in building three-dimensional objects by SFF techniques. This is generally because there are substantial differences between the two processes. For example, in two-dimensional printing a relatively small amount of a liquid solution is jetted. Because only a small amount of material is jetted in two-dimensional printing, the material reservoir for the liquid solution can reside directly in the ink jet print head while providing the ability to print numerous pages before needing to be refilled or replaced. In contrast, a significant amount of material must be dispensed in SDM, which typically requires a large remote reservoir to deliver the material. Undesirably, start up times are longer for SDM techniques using ink jet print heads than in two-dimensional printing due to the length of time necessary to initially heat the material in the large remote reservoir. This also generates a significant amount of heat in the build environment in SDM compared to two-dimensional printing.

Special scanning techniques must also be established in SDM. These scanning techniques are necessary so that the ink jet print head can dispense material to any desired location within the build environment as the three-dimensional object is built. One common scanning technique is disclosed in U.S. Pat. No. 6,136,252 to Bedal et al., where the print head is reciprocally driven in a main scanning direction when selective dispensing occurs at specific target locations positioned along scanning lines extending across the build environment. This type of scanning is generally referred to as raster scanning. In addition to reciprocating the print head in the main scanning direction, it is also desirable to offset the print head relative to the build platform in a secondary scanning direction. This is primarily done so that the scanning lines can be adjusted to provide dispensing in-between previous scanning lines so that all locations within the build environment can be targeted. In addition, in order to compensate for weak or clogged jets, it is desirable to shift or stagger the position of the dispensing jets so that the jets do not dispense along the same line on the object throughout the build process. This is often referred to as randomizing the print head, and is often incorporated into raster scanning techniques utilized in SDM. Further, in SDM scanning techniques it is also necessary to provide scanning movement in the build direction as the layers of the objects are being formed. Thus, SDM scanning techniques generally require motion in three-directions, in the main scanning direction, in the secondary scanning direction, and in the build direction.

A conventional scanning technique for SDM is disclosed in, for example, in U.S. Pat. No. 6,136,252 to Bedal et al., where movement in the main scanning direction is provided by reciprocating the print head in the X-direction, and movement in the secondary scanning direction is provided by offsetting the build platform in the Y-direction. Further, movement in the build direction is provided by shifting or lowering the build platform in the Z-direction.

In SDM it was previously considered impractical to reciprocate the build platform to establish motion in the main scanning direction. It was believed that the acceleration and deceleration forces during reciprocation would damage the objects as they are formed. In addition, it was believed that if the build platform is reciprocated in the main scanning direction, control and targeting problems would occur as the object is formed because the reciprocating mass would continually vary. For example, as the object is built the reciprocating mass would increase, which in turn would alter the reciprocal motion due to changes in the acceleration and deceleration forces in the main scanning direction. It was envisioned that this would cause targeting problems resulting in build failure. Thus, previous scanning techniques such as those disclosed in U.S. Pat. No. 6,136,252 to Bedal et al. reciprocate the dispensing device to provide motion in the main scanning direction.

There are a number of drawbacks to reciprocating the dispensing device in the main scanning direction. Long flexible umbilicals for supplying the material to the dispensing device and for removing the waste material are needed. Undesirably, these umbilicals must flex and move during operation, and must further be heated so the flowable material that they carry does not solidify. Further, a long flexible control circuit board for the print head is needed to transmit the firing pulses to the dispensing device. Undesirably, the longer the chassis the greater is the threat that electromagnetic interference (EMI) can disrupt the build process.

Another drawback is that it is difficult to control the temperature of the dispensing device during the build process. This is because the dispensing device enters and exits a number of different temperature zones within the apparatus as it reciprocates. Reciprocating the print head effectively “fans” the leading and trailing edge of the print head through these zones and subjects the print head to convection heat losses that are especially non-uniform. As discussed in U.S. Pat. No. 5,635,964 to Burr et al., these non-uniform heat losses undesirably affect dispensing drop mass of the print head, particularly as print heads have become wider in order to accommodate additional dispensing orifices.

Hence, these drawbacks increase the complexity, cost, and reliability associated with an SDM apparatus. Thus, it would be preferred to eliminate these drawbacks. These and other difficulties of the prior art are overcome according to the present invention by providing a reciprocating build platform and a substantially stationary dispensing device.

### BRIEF SUMMARY OF THE INVENTION

The present invention provides its benefits across a broad spectrum of SFF processes by providing a unique scanning technique for dispensing material in an SDM apparatus to form a three-dimensional object.

It is one aspect of the present invention to provide a new scanning technique for an SDM apparatus.

It is another aspect of the present invention to provide a more uniform temperature environment for an ink jet print head used in an SDM apparatus.

It is a feature of the present invention that the build platform reciprocates in the main scanning direction while the print head remains substantially stationary in the apparatus.

It is still another feature of the present invention that a biased air flow is directed away from the print head to remove heat from the layers of the object being formed.

It is an advantage of the present invention that it is no longer necessary to provide long feed material umbilicals for delivering build and support material to the print head.

It is another advantage of the present invention that it is no longer necessary to provide long waste removal umbilicals for removing waste material generated when normalizing the layers of the object.

It is yet another advantage of the present invention that it is no longer necessary to provide a long flexible print head control signal chassis to the print head.

It is still yet another advantage of the present invention that the SDM apparatus is significantly simplified by reciprocating the build platform to establish motion in the main scanning direction.

It is still yet another advantage that the dispensing temperature of the print head can be more precisely controlled since it remains substantially stationary in the apparatus and is not subjected to varying air flows.

These and other aspects, features, and advantages are achieved according to the method and apparatus of the present invention that incorporates a new scanning technique that provides for a substantially stationary dispensing device within a SDM apparatus.

### BRIEF DESCRIPTION OF THE DRAWINGS

These and other aspects, features and advantages of the present invention method and apparatus will become apparent upon consideration of the following detailed disclosure of the invention, especially when it is taken in conjunction with the accompanying drawings wherein:

FIG. 1 is a diagrammatic side view of a prior art solid deposition modeling apparatus;

FIG. 2 is a diagrammatic side view of a prior art SDM scanning system practiced by the prior art apparatus of FIG. 1;

FIG. 3 is a diagrammatic isometric view of the prior art SDM scanning system of FIGS. 1 and 2;

FIG. 4 is a diagrammatic side view of an embodiment of the SDM scanning system of the present invention;

FIG. 5 is a diagrammatic isometric view of the SDM scanning system of the present invention;

FIG. 6 is a diagrammatic view of a preferred apparatus for practicing the present invention;

FIG. 7 is an isometric diagrammatic view of a preferred feed and waste system of the apparatus of FIG. 6;

FIG. 8 is a diagrammatic side view of a dispensing trolley of the SDM scanning system of the present invention;

FIG. 9 is a diagrammatic side view of a preferred dispensing trolley of the SDM scanning system of the present invention; and

FIG. 10 is an isometric view of a SDM apparatus of the embodiment shown schematically in FIG. 6.

To facilitate understanding, identical reference numerals have been used, where possible, to designate identical elements that are common to the figures.

### DETAILED DESCRIPTION OF THE PREFERRED EMBODIMENTS

The present invention provides its benefits across a broad spectrum of SFF processes. While the description which follows hereinafter is meant to be representative of a number of such applications, it is not exhaustive. As will be understood, the basic apparatus and methods taught herein can be readily adapted to many uses. It is intended that this specification and the claims appended hereto be accorded a breadth in keeping with the scope and spirit of the invention being disclosed despite what might appear to be limiting language imposed by the requirements of referring to the specific examples disclosed.

While the present invention is applicable to all SDM techniques and objects made therefrom, the invention will be described with respect to solid deposition modeling utilizing a curable phase change build material and phase change support material dispensed in a flowable state. However it is to be appreciated that the present invention can be implemented with any SDM technique utilizing a wide variety of materials. For example, the build material can be a photocurable or sinterable material that is heated to a flowable state but when solidified may form a high viscosity liquid, a semi-solid, a gel, a paste, or a solid. In addition, the build material may be a composite mixture of components, such as a mixture of photocurable liquid resin and powder material such as metallic, ceramic, or mineral, if desired.

As used herein, the term “a flowable state” of a build material is a state wherein the material is unable to resist shear stresses that are induced by a dispensing device, such as those induced by an ink jet print head when dispensing the material, causing the material to move or flow. Preferably the flowable state of the build material is a liquid state, however the flowable state of the build material may also exhibit thixotropic properties. The term “solidified” and “solidifiable” as used herein refer to the phase change characteristics of a material where the material transitions from the flowable state to a non-flowable state. A “non-flowable state” of a build material, as used herein, is a state wherein the material is sufficiently self-supportive under its own weight so as to hold its own shape. A build material existing in a solid state, a gel state, a paste state, or a thixotropic state, are examples of a non-flowable state of a build material for the purposes of discussion herein. Further, the term “cured” or “curable” refers to any polymerization reaction. Preferably the polymerization reaction is triggered by exposure to radiation or thermal heat. Most preferably the polymerization reaction involves the cross-linking of monomers and oligomers initiated by exposure to actinic radiation in the ultraviolet or infrared wavelength band. Further, the term “cured state” refers to a material, or portion of a material, in which the polymerization reaction has substantially completed. It is to be appreciated that as a general matter the material can easily transition between the flowable and non-flowable state prior to being cured, however, once cured, the material cannot transition back to a flowable state and be dispensed by the apparatus.

Additionally, the term “support material” refers to any material that is intended to be dispensed to form a support structure for the three-dimensional objects as they are being formed, and the term “build material” refers to any material that is intended to be dispensed to form the three-dimensional objects. The build material and the support material may be similar materials having similar formulations but, for purposes herein, they are to be distinguished only by their intended use. A preferred method for dispensing a curable phase change material to form a three-dimensional object and for dispensing a non-curable phase change material to form supports for the object is disclosed in U.S. patent application Ser. No. 09/971,337 filed Oct. 3, 2001 entitled “Selective Deposition Modeling with Curable Phase Change Materials.” A preferred curable phase change material and non-curable phase change support material is disclosed in U.S. patent application Ser. No. 09/971,247 filed Oct. 3, 2001 entitled “Ultra-Violet Light Curable Hot Melt Composition.” A preferred material feed and waste is disclosed in U.S. patent application Ser. No. 09/970,956, filed Oct. 3, 2001 entitled “Quantized Feed System.” All of these related applications are incorporated by reference in their entirety herein.

Furthermore, the term “main scanning direction” refers to the direction of the reciprocal back and forth motion necessary to dispense material to form three-dimensional objects. The three-dimensional objects are formed by dispensing the materials to specific drop locations on raster or scanning lines aligned in the main scanning direction within the build environment. Generally, each raster line is associated with a discharge orifice of the dispensing device. With reference to the figures, the main scanning direction is the direction of the X-axis of the Cartesian coordinate system shown. The term “secondary scanning direction” refers to the sideways motion necessary to offset the raster lines associated with the discharge orifices of the dispensing device relative to the object being formed so the discharge orifices do not dispense along just one path on the object. With reference to the figures, the secondary scanning direction is the direction along the Y-axis of the Cartesian coordinate system shown. The term “build direction” refers to a direction that is perpendicular to the layers being formed by an SDM apparatus. The apparatus must shift the dispensing device relative to the object staging structure in the build direction as the layers are formed during the build process. With reference to the figures the shift in the build direction is the direction along the Z-axis of the Cartesian coordinate system shown. Further, a “substantially stationary” dispensing device refers to a dispensing device in an apparatus that does not move relative to the apparatus when dispensing material in the mains scanning direction, but may move in the secondary scanning direction and build direction when not dispensing material. The term “object staging structure” refers to any structure capable of supporting a three-dimensional object as it is formed in a layerwise manner by an SDM apparatus. For example, a plate or build platform can be used as an object staging structure, as well as a mesh grating or container, if desired.

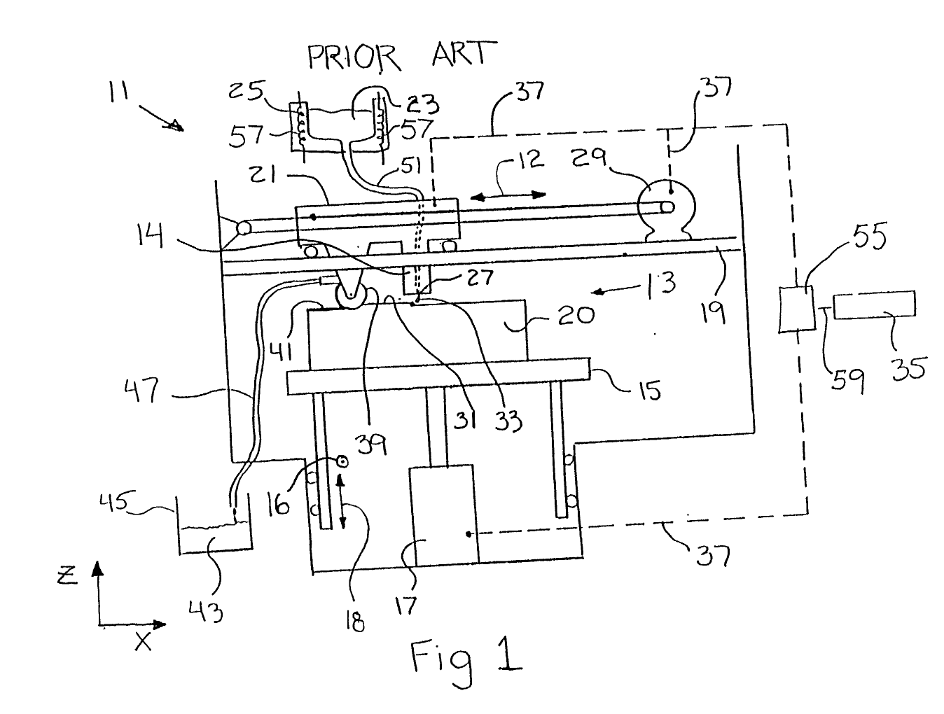

Referring particularly to FIG. 1, there is illustrated generally by the numeral 11 a prior art SDM apparatus. The SDM apparatus 11 is shown building a three-dimensional object 20 in a build environment indicated generally by the numeral 13. The object is built in a layer by layer manner on a build platform 15 that can be precisely positioned vertically by any conventional actuation means 17. The object is built in a layerwise manner by dispensing a build material in a flowable state. Generally, the build material is normally in a non-flowable state and changes to a flowable state when maintained at or above the flowable temperature of the material. The build environment 13 is maintained at a temperature below the flowable temperature of the build material so that the three-dimensional part will solidify as the build material is dispensed. Directly above and parallel to the build platform 15 is a rail system 19 on which a dispensing trolley 21 carrying a dispensing device 14 resides. The rail system 19 guides the motion in the main scanning direction by the dispensing trolley 21 carrying the dispensing device 14.

Generally, the trolley 21 carrying the dispensing device 14 is fed a build material 23 from a remote reservoir 25 due to the large quantity of material typically needed to be dispensed by the SDM apparatus to build a three-dimensional object. In order to dispense the material, a heating means must be provided to heat the material to a flowable state in the reservoir 25 and to maintain the temperature of the material above the flowable temperature of the build material. Preferably, the flowable state of the build material is a liquid state. Changing the material to the flowable state is initially achieved and maintained by the provision of heaters 57 on the reservoir 25 and by the provision of heaters (not shown) on the umbilical 51 connecting the reservoir 25 to the dispensing device 14. Located on the dispensing device 14 is at least one discharge orifice 27 for dispensing the build material. A reciprocating means is provided for the dispensing device 14 which is reciprocally driven on the rail system 19 in the main scanning direction by a conventional drive means 29, such as an electric motor. Generally, the trolley 21 carrying the dispensing device 14 makes multiple passes to dispense one complete layer of material from the discharge orifice 27. In FIG. 1, a portion of a layer of dispensed material 31 is shown as the trolley has just started its pass from left to right. A dispensed droplet 33 is shown in mid-flight, and the distance between the discharge orifice 27 and the layer 31 of build material is greatly exaggerated for ease of illustration. The dispensed droplets 33 from each orifice hit desired drop locations positioned along the scanning line associated with the discharge orifice. Also shown in FIG. 1, is a planarizer 39 that is used to successively shape the layers as needed. Such shaping is typically needed in order to eliminate the accumulated effects of drop volume variation, thermal distortion, and the like, which occur during the build process. After shaping, a smooth uniform layer is achieved as indicated by numeral 41. Excess material 43 removed by the planarizer 39 travels through a waste umbilical 47 to waste bin 45. Depending on the nature of the material and the operating characteristics of the system, the waste material 43 may be discarded or recycled.

Preferably, a remote computer 35 takes a CAD data file and generates three-dimensional coordinate data of an object, commonly referred to as an STL file. When a user desires to build an object, a print command is executed at the remote computer 35 in which the STL file is processed through print client software that is sent to the SDM apparatus 11 as a print job. The print job is transmitted to the computer controller 55 of the SDM apparatus by any conventional data transferable medium desired, such as by magnetic disk tape, microelectronic memory, or the like, as indicated by numeral 59. The data transmission route and controls of the SDM apparatus are represented as dashed lines at 37. The data is processed into object layer data for each layer of the three-dimensional object and into object support layer data for supporting the three-dimensional object as it is built. A computer controller 55 utilizes the object layer data and object support data to produce the appropriate control commands to operate the apparatus to form the three-dimensional object.

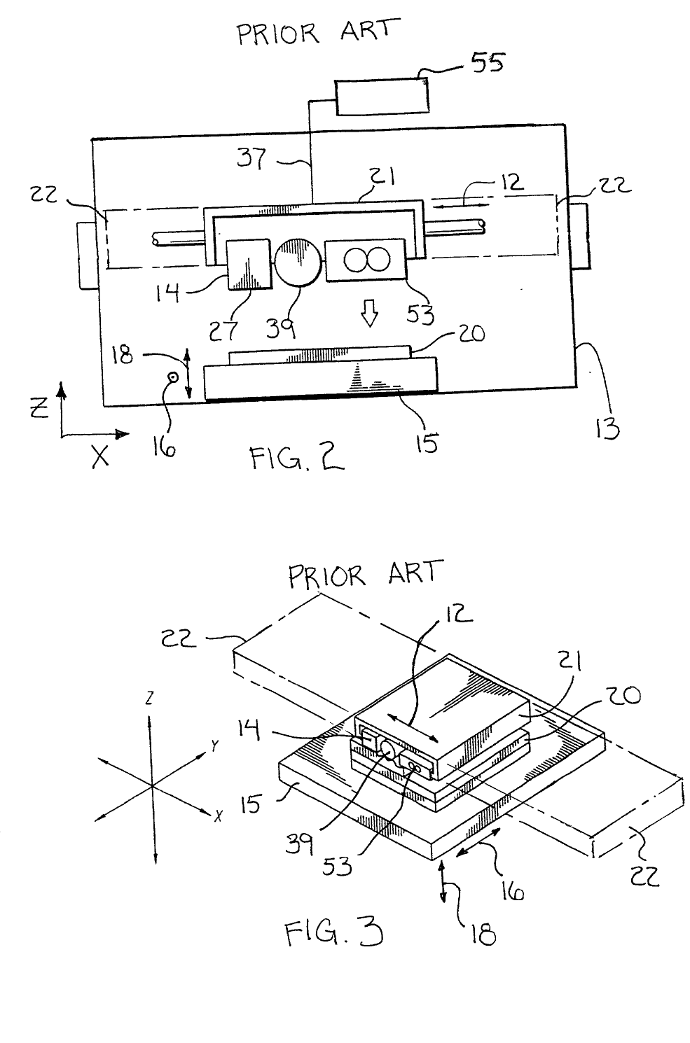

The dispensing device 14 shown in the FIG. 1 reciprocates in the main scanning direction between opposed ends in the build environment while the build platform 15 remains substantially stationary. The opposed ends of travel in the main scanning direction, identified by numerals 22 in FIGS. 2 through 5, define in one direction the greatest width of the build environment in which three-dimensional objects can be made by the apparatus. Although the build platform is stationary as the dispensing device reciprocates in the main scanning direction, the build platform is shifted in the secondary scanning direction, as needed, when the dispensing device is at either of the opposed ends 22 of the reciprocating motion in the main scanning direction. Offsetting the build platform in the secondary scanning direction is desirable, for example, to shift the dispensing orifices relative to the object so that they dispense along different lines on the object during the build process. This is generally known as randomization, which is done in order to compensate for the inherent condition that some dispensing orifices will not dispense the same amount of material as others, or that some are clogged and cannot dispense at all. A more detailed discussion of randomization and the reasons for offsetting in the secondary scanning direction in SDM is found in U.S. Pat. No. 6,136,252 to Bedal et al.

The prior art scanning methodology is shown in FIGS. 2 and 3. Generally, the dispensing trolley 21 carrying the dispensing device 14, planarizer 39, and cooling fans 53, are reciprocally driven in the main scanning direction 12 between opposed ends 22 in the build environment 13. The cooling fans 53 direct a cooling stream of air in a direction perpendicular to the layers being formed. Upon contact with the layers the cooling stream spreads out in all directions across the layers. Randomization and offsetting in the secondary scanning direction 16 is accomplished by shifting the build platform 15 instead of the dispensing trolley. The secondary scanning direction 16 is represented as a circle and dot in FIG. 2 since it is coincident with the line of sight of that view. The SDM computer controller or processor 55 coordinates these motions and provides the firing pulses to the dispensing orifices 27 to dispense the material on targeted drop locations on the scanning lines. In contrast to two-dimensional printing techniques, SDM requires movement in the build direction 18 to compensate for the formation of each layer of the three-dimensional object. In the prior art scanning methodology shown in FIGS. 2 and 3, movement in the build direction 18 is accomplished by shifting or lowering the build platform 15 in the build direction 18 after each layer is formed.

There are a number of drawbacks to the prior art scanning methodology shown in FIGS. 2 and 3. For example, since the dispensing trolley 21 is reciprocated between opposed ends 22, long reciprocating umbilicals for supplying the material to the dispensing device 14 are needed, as well as long reciprocating umbilicals for removing >waste material generated by the planarizer 39. Further, a long flexible circuit board for the print head is needed to transmit the firing pulses to the dispensing device. Configuring these flexible umbilicals and circuit board undesirably adds complexity to the prior art apparatus.

Furthermore, it is difficult to control the temperature of the dispensing device during the build process when reciprocating the dispensing device 14 within in the build environment 13 because the dispensing device is subjected to different temperature zones within the apparatus. These zones can vary substantially in temperature due to the cyclical turbulent air flow occurring within the apparatus. The dispensing device is therefor subjected to undesirable temperature variations which undesirably affect the dispensing drop mass during layer formation. This occurs because the dispensing drop mass for most dispensing devices are temperature sensitive, and particularly so for piezoelectric driven ink jet print heads.

It was previously believed that these drawbacks are generally unavoidable. It was considered impractical to reciprocate the build platform in the main scanning direction, and therefor believed that the dispensing device must be reciprocally driven in the main scanning direction. In addition, it was believed that control and targeting problems would occur as the object is formed because the reciprocating mass would continually change during the build process. However, the effects of varying mass are negligible and can be effectively eliminated by providing a robust reciprocating drive means which is load matched to account for the reciprocation of varying mass. For example, providing a gear reduction ratio between the motor 29 that drives the reciprocation of the build platform can allow the motor to be driven at a higher speed and under lower torque conditions. This approach overcomes the problems believed to be associated with reciprocating a varying mass on the build platform.

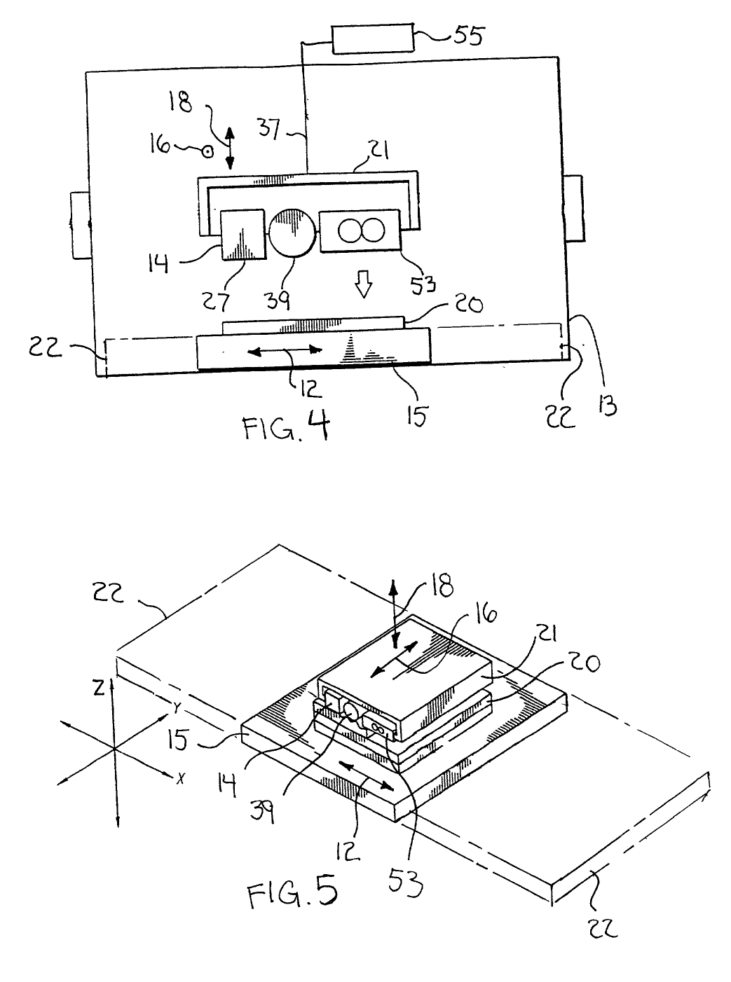

Now, referring to FIGS. 4 and 5, a new scanning methodology is shown that overcomes the drawbacks and problems of the prior art scanning methodology. Uniquely, the build platform 15 is reciprocally driven in the main scanning direction 12 between opposed ends 22 in the build environment 13, instead of the dispensing trolley 21. The dispensing trolley 21 remains substantially stationary during motion in the main scanning direction. Preferably the dispensing trolley is offset in the secondary scanning direction 16 for randomization when the build platform is at the opposed ends 22 of the reciprocating motion in the main scanning direction, and is shifted upward in the build direction after each layer is formed. Alternatively, the build platform may be offset in the secondary scanning direction and shifted downward in the build direction, if desired. In either case, the dispensing device remains substantially stationary when motion occurs in the main scanning direction during dispensing.

This new scanning methodology provides significant advantages over the prior art. Since the offset in the secondary scanning direction 16 is substantially minor compared to the reciprocal motion of the build platform in the main scanning direction, all the long umbilicals needed for supplying material and removing waste material are eliminated. Further, the temperature for the dispensing device 14 can be maintained more constant and uniform since the device remains substantially stationary in the apparatus and is not subject to cyclical turbulent air flow. Thus, it is easier to control the air flow around, and therefore the temperature of, a substantially stationary dispensing device in an SDM apparatus. With more precise control of the dispensing temperature, more precise control of the drop mass from the dispensing head is achieved. Furthermore EMI effects are minimized as the print head control signal chassis lines 37 is substantially shortened. Power consumption of the apparatus is also substantially reduced. As SDM methods have evolved, the mass and volume of space of the dispensing trolley and its accompanying components has substantially increased well in excess of the mass and volume of space reserved for the object and platform. Power consumption is thus reduced because less energy is needed to accelerate and decelerate the smaller mass of the platform and object, which also provides for better control of the reciprocal motion. In addition, utilization of space within the apparatus is more efficiently used since it is the smaller volume of space occupied by the platform and object that is reciprocally driven. Another advantage is that when the object is finished, the build platform can be positioned at one end 22 of the main scanning direction to provide significantly more access to the object for removal than in prior art SDM systems.

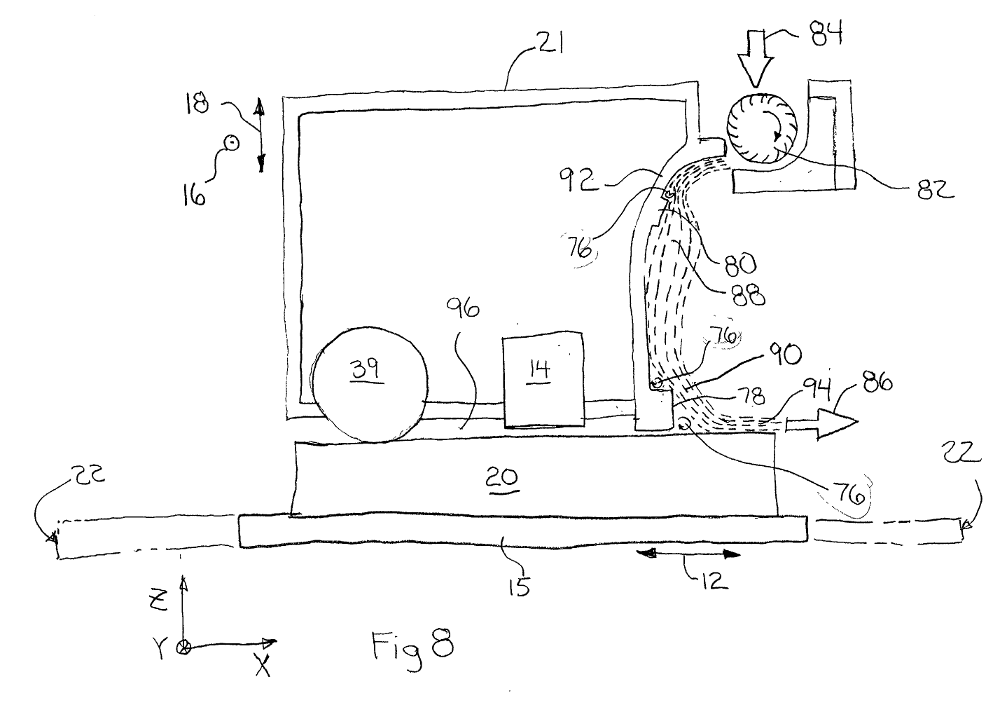

Referring to FIG. 8 a preferred dispensing trolley 21 is shown for executing the scanning techniques of the present invention. Unique to the dispensing trolley 21 is the provision of a biased air flow 90 for cooling the object. Since the preferred build material is curable by exposure to actinic radiation, a significant amount of heat is generated during the layer formation process. This heat must be removed without affecting the temperature of the dispensing device. The prior art cooling fans 53 shown in FIGS. 2 and 3 provide an air profile in the shape of an inverted “T” that moves vertically downward towards the object and then distributes in all directions over the surface of the object. Since the amount of heat to be removed in the prior SDM systems utilizing non-curable phase change materials is not as significant as with the preferred curable materials herein, the inverted “T” air profile was sufficient for cooling objects in the prior SDM systems. However, increasing the air velocity of the inverted “T” air profile to meet the cooling capacity needed for curable materials undesirably affects the dispensing temperature of the ink jet print head. As the dispensing temperature drops, so to does the drop mass of the dispensed material. Thus, nonuniform temperature distributions around the print head create non-uniform drop mass of ejected material droplets across the print head array. Prior scanning techniques that reciprocate the print head throughout the build environment further magnifies the problem of a non-uniform temperature drop across the print head.

Part of the solution to providing a uniform temperature for the print head is to maintain the print head substantially stationary within the apparatus to prevent convection cooling caused by “fanning” the device through different temperature zones within the apparatus. Referring to FIG. 8, the print head 14 is mounted on the dispensing trolley 21 with the planarizer 39 and remains substantially stationary in the apparatus while the build platform is reciprocated in the main scanning direction 12. The print head 14 remains substantially stationary in the apparatus and preferably only moves in the secondary scanning direction 16 for randomization, and in the build direction 18 after each layers is formed. The print head 14 is substantially stationary because it does not move when material is dispensed during motion in the main scanning direction 12 by the build platform 15. In addition, the motions in the secondary scanning direction 16 and build direction 18 are substantially small movements compared to the movement in the mains scanning direction 12. These small movements have essentially no impact on the temperature distribution of the print head. Although it is preferred to offset the dispensing trolley in the secondary scanning direction and shift it in the build direction, the build platform may alternatively be driven to perform all scanning motions in the apparatus, if desired. Thus, a completely stationary dispensing device within the apparatus can be provided, if desired. In order to maintain a uniform dispensing temperature for the print head 14 it is further necessary to substantially eliminate the transient convection air flows occurring around the print head. However, this must be accomplished while still providing the higher cooling rates required for the layers of the object while it is being formed. Referring to FIG. 8, a biased air flow 90 for cooling the object is provided on the dispensing trolley 21. Uniquely, the biased air flow 90 is directed away from the print head 14 so that it will not affect the temperature for the print head while removing heat from the object 20 being formed below. Cooling air enters a centrifugal fan blower 82 as indicated by arrow 84. The centrifugal fan blower 82 is elongated and extends the entire length of the print head 14 in the Y-direction, which is coincident with the line of sight of FIG. 8. The blower 82 ejects the air outwardly in a horizontal manner as a sheet of air towards a curved baffle 92 which re-directs the sheet of air vertically toward the object 20 being formed. Importantly, the flow of air is shaped as a uniform sheet of air so that uniform cooling can be achieved across the surface of the layers. A protrusion 80 is provided to initially trip the flow of air to thicken the width of the sheet as shown at 88. At the end of the curved baffle 92 is another protrusion 78. The protrusions 78 and 80 establish high pressure zones 76 which impart a sideways force on the stream of air that diverts the stream air flow away from the print head 14. The diverted flow path is shown by numeral 90. The width of the biased flow of air starts to thin as it approaches the object 20 so that the flow achieves its maximum velocity as it traverses the object 20. The point where the flow traverses the object 20 is shown by numeral 94. Heat is transferred by convection from the object 20 to the air flow which travels away from the object and print head in the direction noted at 86. Importantly, the air flow 90 is biased away from the print head 14 to substantially prevent active cooling of the print head 14. This is true even when the biased air flow does not traverse the object 20, such as when the build platform 15 is located at the left opposed end 22 in FIG. 8. However, as the build platform 15 moves from right to left, the air flow 90 is diverted across the surface of the object 20.

With the air flow biased away from the print head 14, the velocity of the air flow can be substantially increased in order to achieve the desired heat transfer rate necessary for removing the heat being released from the layers of curable materials. In addition, with the print head positioned between the biased air flow 90 and the planarizer 39, a pocket of air 96 is established around the print head 14. This pocket or buffer zone of air 96 is substantially undisturbed within the apparatus and provides an insulating or shielding effect around the print head. This in turn allows for more uniform temperature control of the print head 14. Thus, providing a more uniform temperature environment for the print head 14 is achieved by providing a substantially stationary print head within the apparatus, by providing a biased flow of air over the object directed away from the print head, and by providing an insulating or shielding pocket of air around the print head.

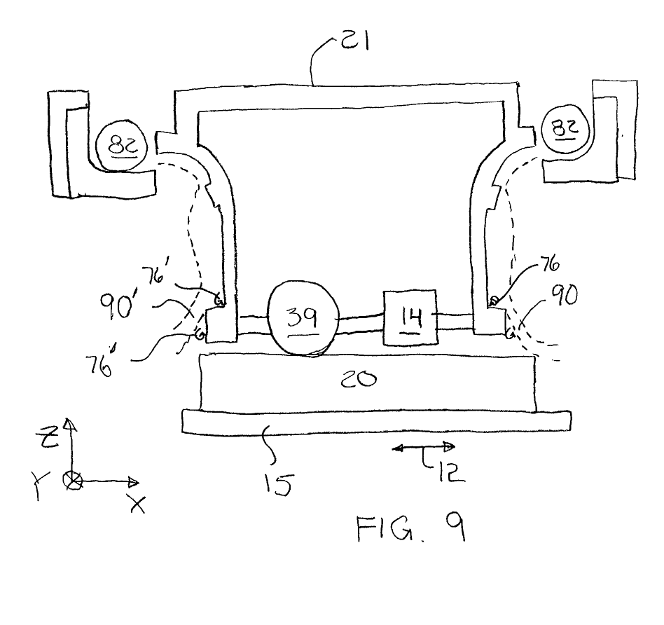

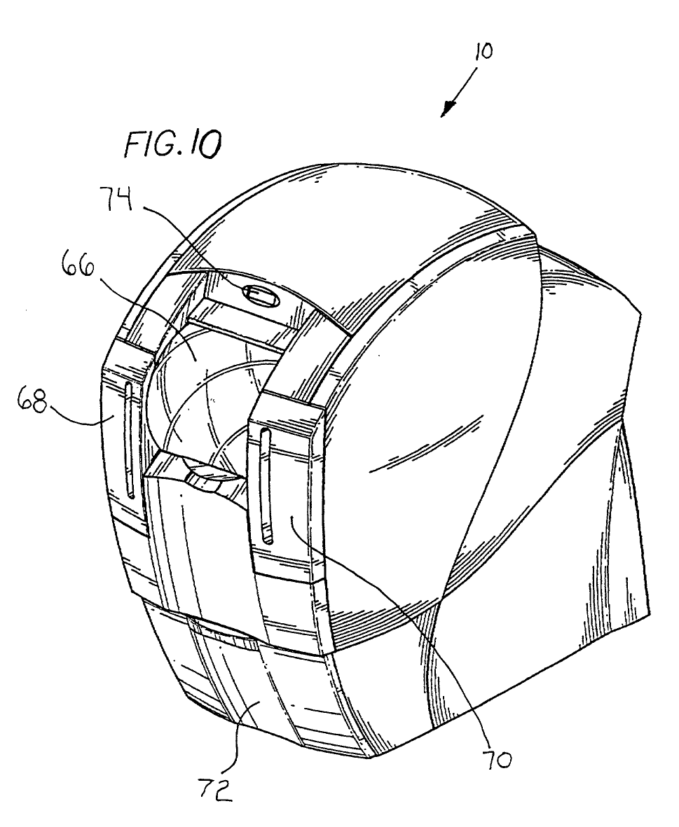

The dispensing trolley in FIG. 8 shows just one biased air flow 90 for cooling the object 20. In a preferred embodiment shown in FIG. 9, a second biased air flow 90′ for cooling the object is provided on the left side of the dispensing trolley adjacent to the planarizer 39. The second biased air flow 90′ is the mirror image of the one shown in FIG. 8. The second biased air flow is diverted outwardly to the left. Utilizing two biased air flows is preferred since it effectively doubles the convention heat transfer capabilities of the system. This is desirable when working with curable materials that generate significant amounts of heat within the SDM apparatus.

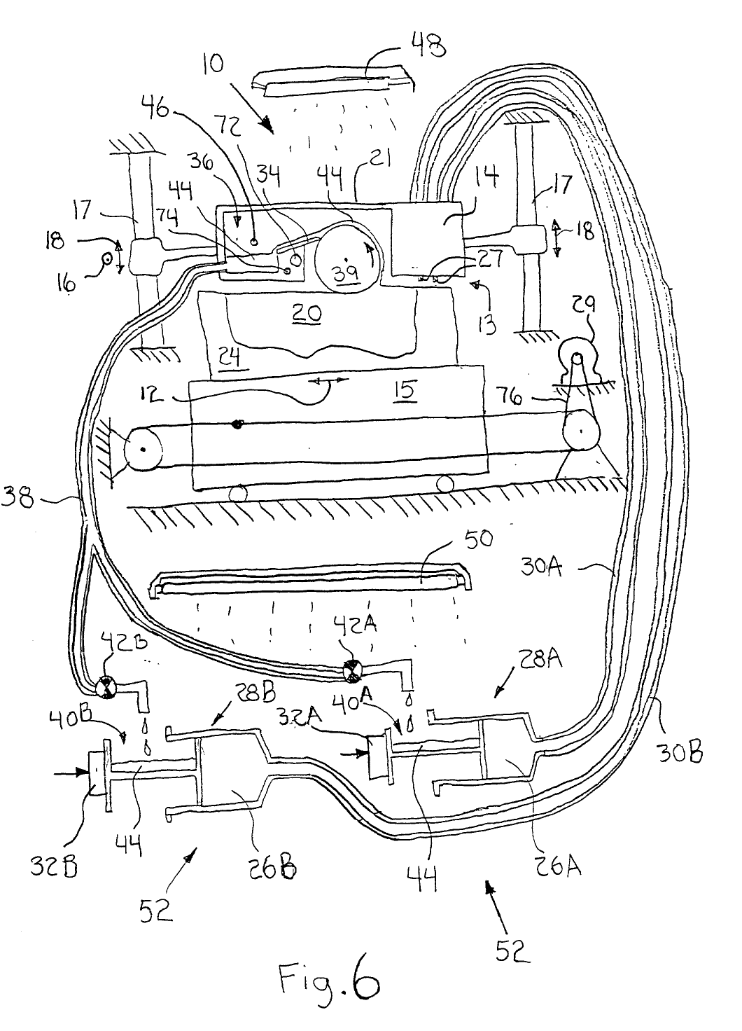

Referring particularly to FIG. 6 there is illustrated generally by the numeral 10 a solid freeform fabrication apparatus adapted to practice the new scanning methodology shown in FIGS. 4 and 5. In contrast to the prior art apparatus shown in FIG. 1, the build platform 15 is reciprocally driven by the conventional drive means 29, instead of the dispensing trolley. A gear reduction means 76 is provided so that the motor 29 can be driven at a high speed under low torque conditions. This eliminates the control problems associated with accelerating and decelerating a varying mass. The dispensing trolley 21 is precisely positioned by actuation means 17 in the build direction to adjust for each layer of the object 20 as it is formed. Preferably the actuation means 17 comprises precision lead screw linear actuators driven by servomotors (both not shown). In the preferred embodiment the ends of the linear actuators of the actuation means 17 reside on opposite ends of the build environment 13 and in a transverse direction to the direction of reciprocation of the build platform. In this transverse direction, which is in line with the secondary scanning direction 16, the dispensing trolley 21 is shifted to execute randomization as discussed previously. However, for ease of illustration in FIG. 6 the linear actuators and dispensing trolley are shown in a two-dimensionally flat manner giving the appearance that the linear actuators are aligned in the direction of reciprocation of the build platform 15. Although they may be aligned with the direction of reciprocation, it is preferred they be situated in a transverse direction so as to optimize the use of space within the apparatus.

In the build environment generally illustrated by numeral 13, there is shown by numeral 20 a three-dimensional object being formed with integrally formed supports 24. The object 20 and supports 24 both reside in a sufficiently fixed manner on the build platform 15 so as to withstand the acceleration and deceleration forces induced during reciprocation of the build platform while still being removable from the platform. This is achieved by dispensing at least one layer of support material on the build platform before dispensing the build material since the support material is designed to be removed at the end of the build process. In this embodiment, the material identified by numeral 26A is dispensed by the apparatus 10 to form the three-dimensional object 20, and the material identified by numeral 26B is dispensed to form the support 24. Containers identified generally by numerals 28A and 28B respectively hold a discrete amount of these two materials 26A and 26B. Umbilicals 30A and 30B respectively deliver the material to the dispensing device 14, which in the preferred embodiment is an ink jet print head having a plurality of dispensing orifices 27.

Preferably the materials 26A and 26B are phase change materials that are heated to a liquid state, and heaters (not shown) are provided on the umbilicals 30A and 30B to maintain the materials in a flowable state as they are delivered to the dispensing device 14. In this embodiment the ink jet print head is configured to dispense both materials from a plurality of dispensing orifices so that both materials can be selectively dispensed in a layerwise fashion to any target location on any raster line associated with a dispensing orifice. Since the ink jet print head is shifted in the secondary scanning direction, the materials can be dispensed to any location in any layer being formed. When the dispensing device 14 needs additional material 26A or 26B, plunger members 32A and 32B are respectively engaged to extrude the material from the containers 28A and 28B, through the umbilicals 30A and 30B, and to the dispensing device 14.

The dispensing trolley 21 in the embodiment shown in FIG. 6 comprises a heated planarizer 39 that removes excess material from the layers to normalize the layers being dispensed. The heated planarizer 39 contacts the material in a non-flowable state and because it is heated, locally transforms some of the material to a flowable state. Due to the forces of surface tension, this excess flowable material adheres to the surface of the planarizer, and as the planarizer rotates the material is brought up to the skive 34 which is in contact with the planarizer 39. The skive 34 separates the material from the surface of the planarizer 39 and directs the flowable material into a waste reservoir identified generally by numeral 36 located on the trolley 21. A heater 72 and thermistor 74 on the waste reservoir 36 operate to maintain the temperature of the waste reservoir at a sufficient level so that the waste material in the reservoir remains in the flowable state. The preferred dispensing trolley 21 is configured to have two biased air flows 90 for cooling the object as shown in FIG. 9, however the air flows have been omitted in FIG. 6 for ease of illustration.

The waste reservoir is connected to a heated waste umbilical 38 for delivery of the waste material 44 to the waste receptacles 40A and 40B. The waste material is allowed to flow via gravity down to the waste receptacles 40A and 40B. Although only one umbilical 38 with a splice connection to each waste receptacle is shown, it is preferred to provide a separate waste umbilical 38 between the waste reservoir 36 and each waste receptacle 40A and 40B.

For each waste receptacle 40A and 40B, there is associated a solenoid valve 42A and 42B, for regulating the delivery of the waste material to the waste receptacles. Preferably the valves 42A and 42B remain closed, and only open when the respective extrusion bars 32A and 32B are energized to remove additional material. For example, if only plunger member 32A is energized, only valve 42A opens to allow the waste material 44 to flow into waste receptacle 40A. This feedback control of the valves prevents delivery of too much waste material to either waste receptacle, by equalizing the delivery of the waste material in the waste receptacles in proportion to the rate at which material is fed from the containers to the dispensing device. Thus, the delivery of waste material to the waste receptacles is balanced with the feed rates of build material and support material of the feed system.

In the embodiment of FIG. 6, an additional detection system is provided in the waste system to prevent the waste material from overflowing the waste reservoir 36. The system comprises an optic sensor 46 provided in the waste reservoir 36 that detects an excess level of waste material in the reservoir. If the level of the waste material in the waste reservoir 36 raises above a set level, the sensor 46 detects it. The sensor 46 in turn provides a signal to the computer controller 55 of FIG. 4, which shuts down the apparatus. This prevents waste material from flooding the components inside the apparatus in the event of a malfunction of the feed and waste system. The apparatus can then be serviced to correct the malfunction thus preventing excessive damage to the apparatus.

In the embodiment shown in FIG. 6, the build material 26A is a phase change material that is cured by exposure to actinic radiation. After the curable phase change material 26A is dispensed in a layer it transitions from the flowable state to a non-flowable state. After a layer has been normalized by the passage of the planarizer 39 over the layer, the layer is then exposed to actinic radiation by radiation source 48. Preferably the actinic radiation is in the ultraviolet or infrared band of the spectrum. It is important, however, that planarizing occurs prior to exposing a layer to the radiation source 48. This is because the preferred planarizer can only normalize the layers if the material in the layers can be changed from the non-flowable to the flowable state, which cannot occur if the material 26A is first cured.

In conjunction with the curable build material 26A, a non-curable phase change material is used for the support material 26B. Since the support material cannot be cured, it can be removed from the object and build platform, for example, by being dissolved in a solvent or by being melted by application of heat. A preferred method for removing the support material is disclosed in U.S. patent application Ser. No. 09/970,727 filed Oct. 3, 2001 entitled “Post Processing Three-Dimensional Objects Formed by Selective Deposition Modeling” which is herein incorporated by reference.

In this embodiment the waste material comprises both materials as they accumulate during planarizing. Preferably, a second radiation source 50 is provided to expose the waste material in the waste receptacles to radiation to cause the material 26A to cure so that there is no reactive material in the waste receptacles.

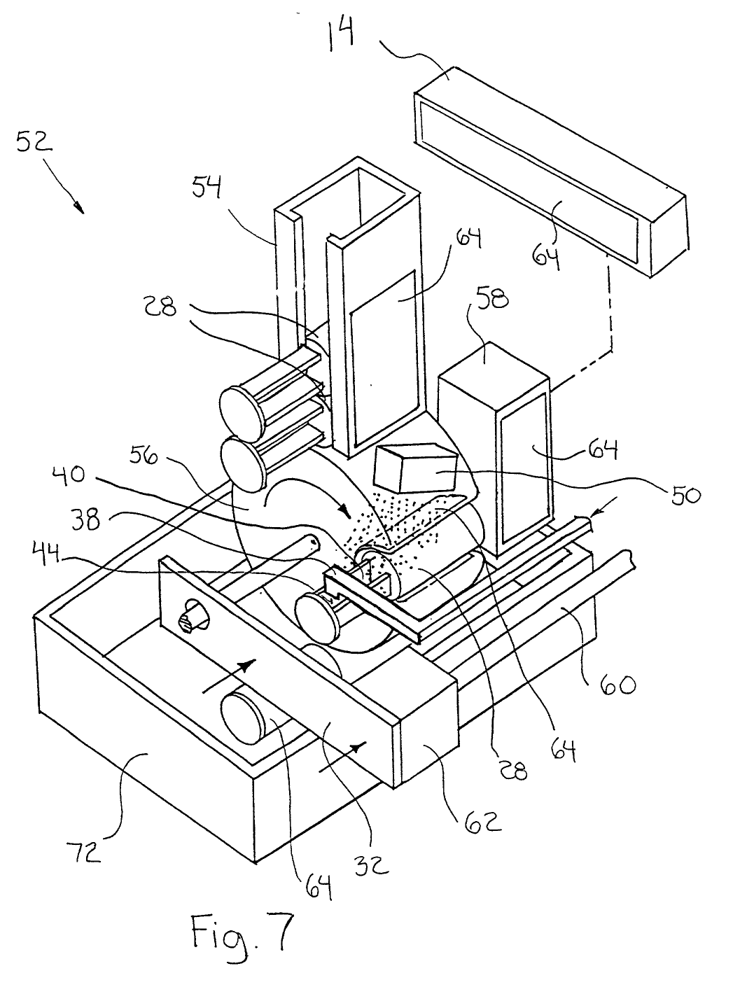

The apparatus shown in FIG. 6 is provided with two feed systems 52. One feed system delivers the build material 26A, and the other delivers the support material 26B. The two feed systems 52 are basically identical, and for ease of discussion only one feed system 52 is shown in greater detail in FIG. 7. Referring to FIG. 7, a queue station 54 forms a magazine for holding a plurality of containers 28. The containers hold a discrete amount of build material that is initially in a non-flowable state. Preferably the containers 28 are cartridges containing unused material and are initially loaded into the magazine manually by an operator. However the loading process could be automated, if desired. In this embodiment the cartridges are stacked in a linear fashion. A mechanical indexer 56 receives the cartridges 28 and then rotates them into a position where a plunger member 32 applies force to the cartridge to remove the build material from the cartridge. The material is removed through an orifice at the cartridge's end and is delivered into a filter 58. The plunger member 32 is biased axially along a shaft 60 by a feed motor 62. As the plunger member 32 applies the force to expel the build material, the material passes through the filter 58 and is delivered to the dispensing device 14.

The material in the cartridges are delivered to the queue station 54 while the build material is in a non-flowable state. Heater elements, identified by numeral 64 are situated on the queue station 54, on the indexer 56, on the filter 58, and on the print head 14. The heater elements 64 provide heat to change the build material to the flowable state and to maintain the build material in the flowable state as it moves through the delivery system to the print head 14. Preferably the build material transforms from the non-flowable state to the flowable state in the cartridge prior to being delivered to the indexer 56, although this is not required.

A waste removal means is also integrated with the build material feed system 52. Waste material 44 generated during planarizing is returned through a waste umbilical 38 and is delivered to a waste receptacle 40 provided on the container 28. Referring to FIG. 7, the waste removal means is unique in that it can take reactive waste material, such as an uncured photopolymer material, and seal the waste material in each cartridge prior to ejecting each cartridge into waste drawer 72. Desirably, the sealed and ejected containers 64 can be directly handled by personnel in an office environment, thereby eliminating the need for special handling procedures for the waste material. When the containers are ejected into waste drawer 72, the indexer 56 then loads a new container for dispensing additional material.

As discussed in conjunction with the apparatus shown in FIG. 6, there are two basically identical feed systems 52, one for dispensing the build material and the other for dispensing the support material. Preferably the support material cartridges are configured such that they can not be inserted into the build material magazine. Likewise, the build material cartridges are configured such that they can not be inserted into the support material magazine. Such special keying of the cartridges and magazines eliminates the possibility of inadvertently mixing the materials in the apparatus. In the preferred embodiment, the waste material comprises portions of both the build material and the support material, which are delivered to the waste receptacle of the support material cartridge and build material cartridge.

Now referring to FIG. 10, the SDM apparatus schematically shown in FIG. 6 is shown at 10. To access the build environment, a slideable door 66 is provided at the front of the apparatus. The object can be easily removed when the build platform (not shown) is positioned at the opposed end of reciprocation adjacent slideable door 66. The door 66 does not allow radiation within the machine to escape into the environment. The apparatus is configured such that it will not operate or turn on when the door 66 open. In addition, when the apparatus is in operation the door 66 will not open. A build material feed door 68 is provided so that the build material containers can be inserted into the previously described queue station 54 (not shown) of the apparatus 10. A support material feed door 70 is also provided so that the support material can be inserted into the previously described queue station 54 (not shown) of the apparatus 10. A waste drawer 72 is provided at the bottom end of the apparatus 10 so that the expelled waste containers can be removed from the apparatus. A user interface 74 is provided which is in communication with the external computer 35 previously discussed which tracks receipt of the print command data from the external computer.

What has been described are preferred embodiments in which modifications and changes may be made without departing from the spirit and scope of the accompanying claims.

What is claimed is:

1. A method of forming a three-dimensional object by selectively dispensing a build material from a dispensing device in a layerwise manner over a object staging structure, the method comprising:
processing data to establish object layer data;
establishing motion in a main scanning direction by reciprocating the object staging structure relative to the dispensing device;
dispensing the build material from the dispensing device during the reciprocating motion of the object staging structure in the main scanning direction according to the object layer data to form layers of the three-dimensional object.

2. The method of claim 1 wherein the dispensing device remains substantially stationary during the step of dispensing the build material.

3. The method of claim 1 wherein the reciprocating motion in the main scanning direction establishes at least one raster line for the dispensing device extending between opposed ends in a build environment over the object staging structure, and the build material is dispensed on selected target locations on the raster line.

4. The method of claim 1 further comprising the step of:
shifting the dispensing device in a build direction after each layer of the three-dimensional object is formed.

5. The method of claim 1 further comprising the step of:
shifting the object staging structure in a build direction after each layer of the three-dimensional object is formed.

6. The method of claim 1 further comprising the step of:
offsetting the position of the dispensing device in a secondary scanning direction when the object staging structure is at either opposed end of the reciprocating motion in the main scanning direction.

7. The method of claim 1 further comprising the step of:
offsetting the position of the object staging structure in a secondary scanning direction when the object staging structure is at either opposed end of the reciprocating motion in the main scanning direction.

8. The method of claim 1 further comprising the step of:
normalizing the surface of the layers after each layer has been dispensed to establish a uniform layer thickness for each layer.

9. The method of claim 1 further comprising the step of:
exposing the dispensed build material to actinic radiation to cure the build material.

10. The method of claim 1 further comprising the step of:
providing at least one biased flow of air towards the layers of the three-dimensional object, the biased flow of air being directed away from the dispensing device.

11. The method of claim 1 further comprising:
processing data to establish object support data;
dispensing a support material on selected target locations to form supports for the three-dimensional object.

12. The method of claim 10 wherein the build material and the support material are selectively dispensed from the same dispensing device during the reciprocating motion of the object staging structure in the main scanning direction.

13. A selective deposition modeling apparatus for forming a three-dimensional object by dispensing a build material from a dispensing device in a layerwise fashion over a object staging structure, the apparatus comprising:
a computer controller for processing data to establish object layer data;
a means for supporting the dispensed material, the means for supporting the dispensed material establishing a main scanning direction by reciprocating the object staging structure relative to the dispensing device; and
a means for dispensing the build material from the dispensing device during the reciprocating motion of the object staging structure in the main scanning direction according to the object layer data to form layers of the three-dimensional object.

14. The apparatus of claim 13 wherein the dispensing device remains substantially stationary when dispensing the build material.

15. The apparatus of claim 13 wherein the reciprocating motion in the main scanning direction establishes at least one raster line for the dispensing device extending between opposed ends in a build environment over the object staging structure, and the means for dispensing the build material dispenses the build material on selected target locations on the raster line.

16. The apparatus of claim 13 wherein the dispensing device is an ink jet print head having a plurality of dispensing orifices, each orifice associated with a raster line and dispensing the build material on selected target locations on the associated raster lines.

17. The apparatus of claim 13 further comprising:
means for shifting the dispensing device in a build direction after each layer of the three-dimensional object is formed.

18. The apparatus of claim 13 further comprising:
means for shifting the object staging structure in a build direction after each layer of the three-dimensional object is formed.

19. The apparatus of claim 13 further comprising:
means for offsetting the dispensing device in a secondary scanning direction when the object staging structure is at either opposed end of the reciprocating motion in the main scanning direction.

20. The apparatus of claim 13 further comprising:
means for offsetting the object staging structure in a secondary scanning direction when the object staging structure is at either opposed end of the reciprocating motion in the main scanning direction.

21. The apparatus of claim 13 further comprising:
a means for normalizing the surface of the layers to establish a uniform layer thickness for each layer.

22. The apparatus of claim 13 further comprising:
a means for exposing the build material to actinic radiation to cure the build material.

23. The apparatus of claim 13 further comprising:
means for cooling the layers of the three-dimensional object, the means for cooling providing at least one biased flow of air towards the layers of the three-dimensional object, the path of the biased flow of air being directed away from the dispensing device.

24. The apparatus of claim 13 wherein the computer controller further processing data to establish support layer data to form support for the three-dimensional object, the apparatus further comprising:
a means for dispensing a support material according to the support layer data, the support material being dispensed during motion in the main scanning direction.

25. The apparatus of claim 22 wherein the build material and the support material are both dispensed from the dispensing device.

26. An improved solid freeform fabrication apparatus for forming a three-dimensional object in a layerwise fashion by dispensing at least one material, the apparatus having a build environment including a object staging structure for supporting the three-dimensional object while it is being formed, at least one dispensing device adjacent the object staging structure for dispensing the material to form layers of the three-dimensional object, a means for normalizing the dispensed layers to establish uniform layers for the three-dimensional object, and a computer controller for establishing objet layer data of the three-dimensional object and for controlling the apparatus when forming the three-dimensional object, wherein the improvement comprises;
a reciprocating means establishing a main scanning direction by reciprocating the object staging structure relative to a substantially stationary dispensing device; and
a means for dispensing the build material from the dispensing device during the reciprocating motion of the object staging structure in the main scanning direction according to the object layer data to form layers of the three-dimensional object.

27. The apparatus of claim 26 wherein the reciprocating motion in the main scanning direction establishes at least one raster line for the dispensing device extending between opposed ends in a build environment over the object staging structure, and the means for dispensing the build material dispenses the build material on selected target locations on the raster lines.

28. The apparatus of claim 27 wherein the dispensing device is an ink jet print head having a plurality of dispensing orifices, each orifice associated with a raster line and dispensing the build material on selected target locations on the associated raster lines.

29. The apparatus of claim 27 further comprising:
means for shifting the dispensing device in a build direction after each layer of the three-dimensional object is formed.

30. The apparatus of claim 27 further comprising:
means for shifting the object staging structure in a build direction after each layer of the three-dimensional object is formed.

31. The apparatus of claim 27 further comprising:
means for offsetting the dispensing device in a secondary scanning direction when the object staging structure is at either opposed end of the reciprocating motion in the main scanning direction.

32. The apparatus of claim 27 further comprising:
means for offsetting the object staging structure in a secondary scanning direction when the object staging structure is at either opposed end of the reciprocating motion in the main scanning direction.

33. The apparatus of claim 27 further comprising:
a means for normalizing the surface of the layers to establish a uniform layer thickness for each layer.

34. The apparatus of claim 27 further comprising:
a means for exposing the build material to actinic radiation to cure the build material.

35. The apparatus of claim 27 further comprising:
means for cooling the layers of the three-dimensional object, the means for cooling providing at least one biased flow of air towards the layers of the three-dimensional object, the path of the biased flow of air being directed away from the dispensing device.

36. The apparatus of claim 27 wherein the computer controller further processing data to establish support layer data to form support for the three-dimensional object, the apparatus further comprising:
a means for dispensing a support material according to the support layer data, the support material being dispensed during motion in the main scanning direction.

37. The apparatus of claim 36 wherein the build material and the support material are both dispensed from the dispensing device.
